(19) United States
(12) Patent Application Publication
(10) Pub. No.: US 2024/0399905 A1
(43) Pub. Date: Dec. 5, 2024

(54) APPARATUS AND METHOD FOR ELECTRIC VEHICLE CHARGING

(71) Applicant: BETA AIR, LLC, SOUTH BURLINGTON, VT (US)

(72) Inventors: Jake Pill, SOUTH BURLINGTON, VT (US); Bruce Williams, SOUTH BURLINGTON, VT (US); John Charles Palombini, SOUTH BURLINGTON, VT (US); Richard Donnelly, SOUTH BURLINGTON, VT (US)

(73) Assignee: BETA AIR, LLC, SOUTH BURLINGTON, VT (US)

(21) Appl. No.: 18/204,142

(22) Filed: May 31, 2023

(51) Int. Cl. B60L 53/30; B60L 53/16; B60L 53/18

(52) U.S. Cl. CPC B60L 53/30; B60L 53/16; B60L 53/18; B60L 2210/12; B60L 2210/30

(57) ABSTRACT

A charging apparatus and method for charging an electric vehicle are disclosed. The apparatus includes a housing, a lid, a plurality of cables, and a power switch. The apparatus may further include one or more wheels, lights, and speakers, which are operated in accordance with the functionality of the apparatus. The apparatus can be connected to a 240 V AC wall outlet and output 600 V DC for high-power charging of an electric vehicle such as an aircraft.

### FIELD OF THE INVENTION

The present invention generally relates to the field of electrical chargers. In particular, the present invention is directed to a mobile apparatus and method for electric vehicle charging.

### BACKGROUND

Charging cables are heavy and inconvenient to move, particularly cables used to charge large electric vehicles. There is currently no solution for conveniently moving heavy electric vehicle charging cables.

### SUMMARY OF THE DISCLOSURE

In an aspect, a charging apparatus and method for charging an electric vehicle are disclosed. The apparatus includes a housing, a lid, a plurality of cables, and a power switch. The apparatus may further include one or more wheels, lights, and speakers, which are operated in accordance with the functionality of the apparatus. The apparatus can be connected to a 240 V AC wall outlet and output 600 V DC for high-power charging of an electric vehicle such as an aircraft.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is an illustration of a charging apparatus in accordance with an embodiment of the invention;

FIG. 2 is an illustration of a charging apparatus in accordance with an embodiment of the invention;

FIG. 3 is a flow diagram of a method in accordance with an embodiment of the invention;

FIG. 4A is an illustration of a charging connector in accordance with an embodiment of the invention;

FIG. 4B is an illustration of a charging connector in accordance with an embodiment of the invention;

FIG. 5 is an illustration of an aircraft in accordance with an embodiment of the invention;

FIG. 6 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to a charging apparatus and method for charging an electric vehicle. The apparatus includes a housing, a lid, a plurality of cables, and a power switch. The apparatus may further include one or more wheels, lights, and speakers, which are operated in accordance with the functionality of the apparatus. The apparatus can be connected to a 240 V AC wall outlet and output 600 V DC for high-power charging of an electric vehicle such as an aircraft.

In an embodiment, an apparatus for charging an electric vehicle is provided. The apparatus includes a housing comprising a compartment partially isolated from an external environment, a lid, an electrical cable configured to receive 240 V AC power, and a charging connector and a charging cable, the charging connector and the charging cable configured to deliver DC voltage greater than 100 V.

In an embodiment, a method for charging an electric vehicle is provided. The method includes the steps of providing a housing comprising a compartment partially isolated from an external environment, providing a lid; providing an electrical cable configured to receive 240 V AC power; providing a charging connector and a charging cable, the charging connector and the charging cable configured to deliver DC voltage greater than 100 V; and charging an electric vehicle using the charging connector.

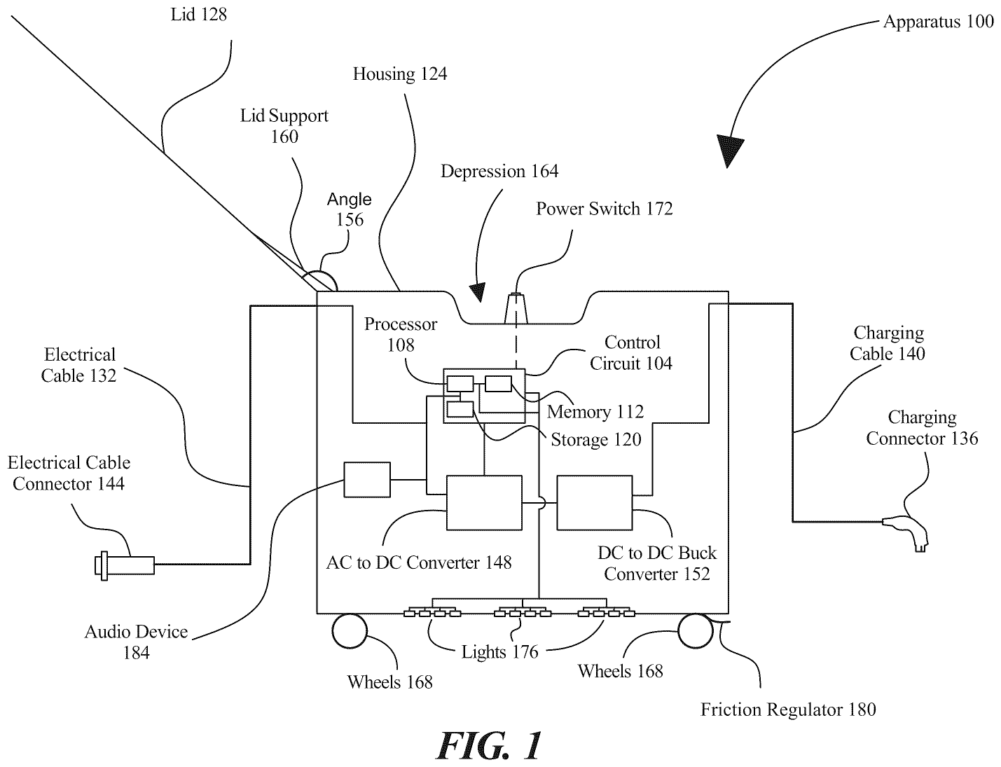

Referring now to FIG. 1, an exemplary embodiment of an apparatus 100 for charging an electric vehicle is illustrated. Apparatus 100 includes a control circuit 104. Control circuit may include, without limitation, a combinational and/or sequential logic circuit, which may be implemented without limitation as a field-programmable gate array (FPGA), an application-specific integrated circuit (ASIC), or the like. Control circuit 104 may include without limitation one or more analog circuit elements and/or computational elements such as without limitation transistors, operational amplifier circuits, diodes, or the like. Control circuit 104 may include a computing device. Computing device may include at least one processor 108 and at least one memory 112 communicatively coupled to the processor 108. Processor 108 may include, without limitation, any processor described in this disclosure. Computing device and/or processor 108 may be communicatively coupled with a storage 120. Processor 108 may be included in a computing device. Computing device may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Computing device may include a single computing device operating independently, or may include two or more computing devices operating in concert, in parallel, sequentially or the like; two or more computing devices may be included together in a single computing device or in two or more computing devices. Computing device may interface or communicate with one or more additional devices as described below in further detail via a network interface device. Network interface device may be utilized for connecting computing device to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device may include but is not limited to, for example, a computing device or cluster of computing devices in a first location and a second computing device or cluster of computing devices in a second location. Computing device may include one or more computing devices dedicated to data storage, security, distribution of traffic for load balancing, and the like. Computing device may distribute one or more computing tasks as described below across a plurality of computing devices of computing device, which may operate in parallel, in series, redundantly, or in any other manner used for distribution of tasks or memory between computing devices. Computing device may be implemented, as a non-limiting example, using a “shared nothing” architecture.

With continued reference to FIG. 1, computing device may be designed and/or configured to perform any method, method step, or sequence of method steps in any embodiment described in this disclosure, in any order and with any degree of repetition. For instance, computing device may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. computing device may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

As used in this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Additional disclosures relating to electric charging, charging control systems, and devices for electric aircraft can be found in U.S. Nonprovisional application Ser. No. 17/736,530,filed on May 4, 2022, and entitled “SYSTEM FOR AN ELECTRIC AIRCRAFT CHARGING WITH A CABLE REEL,” U.S. Nonprovisional application Ser. No. 18/155,375, filed on Feb. 28, 2023, and entitled “SYSTEM FOR AN ELECTRIC AIRCRAFT CHARGING WITH A CABLE REEL,” U.S. Nonprovisional application Ser. No. 17/751,870, filed on May 24, 2022, and entitled “ELECTRIC CHARGING STATION FOR AN ELECTRIC VEHICLE AND A METHOD OF USE,” U.S. Nonprovisional application Ser. No. 18/130,064, filed on Apr. 3, 2023, and entitled “ELECTRIC CHARGING STATION FOR AN ELECTRIC VEHICLE AND A METHOD OF USE,” U.S. Nonprovisional application Ser. No. 17/752,248, filed on May 24, 2022, and entitled, “GROUND SERVICE SYSTEMS AND DEVICES FOR AN ELECTRIC AIRCRAFT,” and U.S. Nonprovisional application Ser. No. 18/116,020, filed on Mar. 1, 2023, and entitled, “GROUND SERVICE SYSTEMS AND DEVICES FOR AN ELECTRIC AIRCRAFT,” each of which is incorporated by reference herein in its entirety.

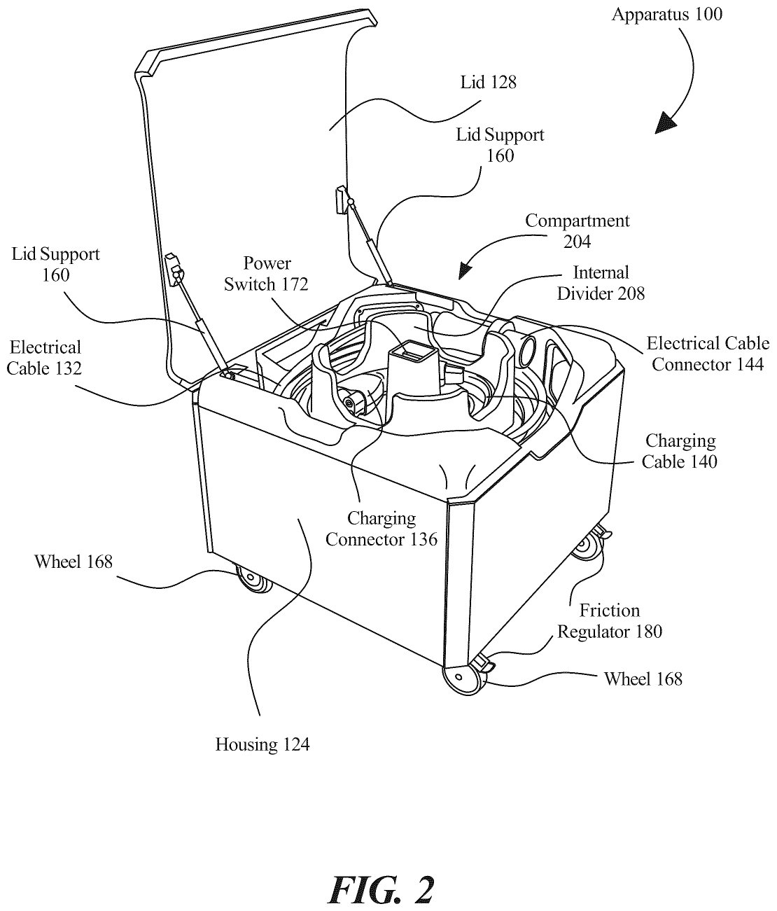

With continued reference to FIG. 1, apparatus 100 includes housing 124, lid 128, electrical cable 132, charging connector 136, charging cable 140. Housing 124 provides a compartment 204 (shown in FIG. 2) which may store electrical cable 132, electrical cable connector 144, charging cable 140, charging connector 136. In an embodiment, housing 124 is made of plastic or another non-conducting material. For example, housing 124 may be made of polyethylene, polypropylene, polytetrafluoroethylene (PTFE), ABS plastic, and the like. Housing 124 may be substantially rectilinear. Housing 124 may be substantially cubic.

With continued reference to FIG. 1, electrical cable 132 may be configured to connect to a standard 240 V AC outlet. Electrical cable 132 may include an electrical cable connector 144 configured to provide a handhold for safely handling the electrical cable 132 as well as a connection for plugging the electrical cable 132 into a power source such as a wall outlet. Electrical cable 132 may be configured to receive 240 V AC power. For example, electrical cable 132 may comprise a twisted pair arrangement of wires. Electrical cable 132 may be insulated, for instance with rubber.

With continued reference to FIG. 1, apparatus 100 may include a charging cable 140. A “charging cable,” for the purposes of this disclosure is a conductor or conductors adapted to carry power for the purpose of charging an electronic device. Charging cable 140 is configured to carry electricity. In an embodiment, charging cable 140 and charging connector 136 are configured to deliver a DC voltage greater than or equal to 100 V. In an embodiment, charging cable 140 and charging connector 136 are configured to deliver a DC voltage greater than or equal to 500 V. In an embodiment, charging cable 140 and charging connector 136 are configured to deliver a DC voltage greater than or equal to 600 V. Charging cable 140 is electrically connected to the energy source. “Electrically connected,” for the purposes of this disclosure, means a connection such that electricity can be transferred over the connection. In some embodiments, charging cable 140 may carry AC and/or DC power to a charging connector 136. The charging cable may include a coating, wherein the coating surrounds the conductor or conductors of charging cable 140. One of ordinary skill in the art, after having reviewed the entirety of this disclosure, would appreciate that a variety of coatings are suitable for use in charging cable 140. As a non-limiting example, the coating of charging cable 140 may comprise rubber. As another non-limiting example, the coating of charging cable 140 may comprise nylon. Charging cable 140 may be a variety of lengths depending on the length required by the specific implementation. As a non-limiting example, charging cable 140 may be 10 feet. As another non-limiting example, charging cable 140 may be 25 feet. As yet another non-limiting example, charging cable 140 may be 50 feet.

With continued reference to FIG. 1, apparatus 100 may include a charging connector 136. Charging cable 140 may be electrically connected to charging connector 136. Charging cable 140 may be configured to transmit up to 5 MW of DC power. Charging connector 136 may be disposed at one end of charging cable 140. Charging connector 136 may be configured to couple with a corresponding charging port on an electric aircraft. For the purposes of this disclosure, a “charging connector” is a device adapted to electrically connect a device to be charged with an energy source. For the purposes of this disclosure, a “charging port” is a section on a device to be charged, arranged to receive a charging connector.

With continued reference to FIG. 1, charging connector 136 may include a variety of pins adapted to mate with a charging port disposed on an electric aircraft. An “electric aircraft,” for the purposes of this disclosure, refers to a machine that is able to fly by gaining support from the air generates substantially all of its trust from electricity. As a non-limiting example, electric aircraft maybe capable of vertical takeoff and landing (VTOL) or conventional takeoff and landing (CTOL). As another non-limiting example, the electric aircraft may be capable of both VTOL and CTOL. As a non-limiting example, electric aircraft may be capable of edgewise flight. As a non-limiting example, electric aircraft may be able to hover. Electric aircraft may include a variety of electric propulsion devices; including, as non-limiting examples, pushers, pullers, lift devices, and the like. The variety of pins included on charging connector 136 may include, as non-limiting examples, a set of pins chosen from an alternating current (AC) pin, a direct current (DC) pin, a ground pin, a communication pin, a sensor pin, a proximity pin, and the like. In some embodiments, charging connector 136 may include more than one of one of the types of pins mentioned above.

With continued reference to FIG. 1, for the purposes of this disclosure, a “pin” may be any type of electrical connector. An electrical connector is a device used to join electrical conductors to create a circuit. As a non-limiting example, in some embodiments, any pin of charging connector 136 may be the male component of a pin and socket connector. In other embodiments, any pin of charging connector 136 may be the female component of a pin and socket connector. As a further example of an embodiment, a pin may have a keying component. A keying component is a part of an electrical connector that prevents the electrical connector components from mating in an incorrect orientation. As a non-limiting example, this can be accomplished by making the male and female components of an electrical connector asymmetrical. Additionally, in some embodiments, a pin, or multiple pins, of charging connector 136 may include a locking mechanism. For instance, as a non-limiting example, any pin of charging connector 136 may include a locking mechanism to lock the pins in place. The pin or pins of charging connector 136 may each be any type of the various types of electrical connectors disclosed above, or they could all be the same type of electrical connector. One of ordinary skill in the art, after reviewing the entirety of this disclosure, would understand that a wide variety of electrical connectors may be suitable for this application.

With continued reference to FIG. 1, in some embodiments, charging connector 136 may include a DC pin. DC pin supplies DC power. “DC power,” for the purposes of this disclosure refers, to a one-directional flow of charge. For example, in some embodiments, DC pin may supply power with a constant current and voltage. As another example, in other embodiments, DC pin may supply power with varying current and voltage, or varying currant constant voltage, or constant currant varying voltage. In another embodiment, when charging connector is charging certain types of batteries, DC pin may support a varied charge pattern. This involves varying the voltage or currant supplied during the charging process in order to reduce or minimize battery degradation. Examples of DC power flow include half-wave rectified voltage, full-wave rectified voltage, voltage supplied from a battery or other DC switching power source, a DC converter such as a buck or boost converter, voltage supplied from a DC dynamo or other generator, voltage from photovoltaic panels, voltage output by fuel cells, or the like.

With continued reference to FIG. 1, in some embodiments, charging connector may include an AC pin. An AC pin supplies AC power. For the purposes of this disclosure, “AC power” refers to electrical power provided with a bi-directional flow of charge, where the flow of charge is periodically reversed. AC pin may supply AC power at a variety of frequencies. For example, in a non-limiting embodiment, AC pin may supply AC power with a frequency of 50 Hz. In another non-limiting embodiment, AC pin may supply AC power with a frequency of 60 Hz. One of ordinary skill in the art, upon reviewing the entirety of this disclosure, would realize that AC pin may supply a wide variety of frequencies. AC power produces a waveform when it is plotted out on a current vs. time or voltage vs. time graph. In some embodiments, the waveform of the AC power supplied by AC pin may be a sine wave. In other embodiments, the waveform of the AC power supplied by AC pin may be a square wave. In some embodiments, the waveform of the AC power supplied by AC pin may be a triangle wave. In yet other embodiments, the waveform of the AC power supplied by AC pin may be a sawtooth wave. The AC power supplied by AC pin may, in general have any waveform, so long as the wave form produces a bi-directional flow of charge. AC power may be provided without limitation, from alternating current generators, “mains” power provided over an AC power network from power plants, AC power output by AC voltage converters including transformer-based converters, and/or AC power output by inverters that convert DC power, as described above, into AC power. For the purposes of this disclosure, “supply,” “supplies,” “supplying,” and the like, include both currently supplying and capable of supplying. For example, a live pin that “supplies” DC power need not be currently supplying DC power, it can also be capable of supplying DC power.

With continued reference to FIG. 1, in some embodiments, charging connector 136 may include a ground pin. A ground pin is an electronic connector that is connected to ground. For the purpose of this disclosure, “ground” is the reference point from which all voltages for a circuit are measured. “Ground” can include both a connection the earth, or a chassis ground, where all of the metallic parts in a device are electrically connected together. In some embodiments, “ground” can be a floating ground. Ground may alternatively or additionally refer to a “common” channel or “return” channel in some electronic systems. For instance, a chassis ground may be a floating ground when the potential is not equal to earth ground. In some embodiments, a negative pole in a DC circuit may be grounded. A “grounded connection,” for the purposes of this disclosure, is an electrical connection to “ground.” A circuit may be grounded in order to increase safety in the event that a fault develops, to absorb and reduce static charge, and the like. Speaking generally, a grounded connection allows electricity to pass through the grounded connection to ground instead of through, for example, a human that has come into contact with the circuit. Additionally, grounding a circuit helps to stabilize voltages within the circuit.

With continued reference to FIG. 1, in some embodiments, charging connector 136 may include a communication pin. A communication pin is an electric connector configured to carry electric signals between components of charging apparatus 100 and components of an electric aircraft. As a non-limiting example, communication pin may carry signals from a controller in a charging system (e.g. processor 108) to a controller onboard an electric aircraft such as a flight controller or battery management controller. A person of ordinary skill in the art would recognize, after having reviewed the entirety of this disclosure, that communication pin could be used to carry a variety of signals between components.

With continued reference to FIG. 1, charging connector 136 may include a variety of additional pins. As a non-limiting example, charging connector 136 may include a proximity detection pin. Proximity detection pin has no current flowing through it when charging connector 136 is not connected to a port. Once charging connector 136 is connected to a port, then proximity detection pin will have current flowing through it, allowing for the controller to detect, using this current flow, that the charging connector 136 is connected to a port.

With continued reference to FIG. 1, housing 124 may enclose or partially enclose internal electrical components including computing device, processor 108, memory 112, AC to DC converter 148, DC to DC buck converter 152, and the like. In an embodiment, computing device, processor 108, memory 112, AC to DC converter 148, and DC to DC buck converter 152 may be communicatively connected to electrical cable 132, charging cable 140, and charging connector 136.

With continued reference to FIG. 1, lid 128 may be movably attached to housing 124. In an embodiment, lid 128 may be rotatably attached to housing 124. Lid 128 may rotate about an edge of housing 124 between a “closed” state and an “open” state. A “closed” state as used herein in reference to lid 128 and housing 124 is defined as the lid being substantially in contact with housing 124 along a plurality of edges. In a closed state, lid 128 covers all or substantially all of compartment 204. An angle 156 of lid 128 with respect to the top of housing 124 in a closed state is 0°. Lid 128 may be opened by rotating the lid away from a top surface of housing 124. Lid 128 may open to a maximum angle of 120°, 150°, or the like. Lid 128 may be partially connected to housing 124 by one or more lid supports 160. Lid support 160 may be a spring, a gas cylinder, a bungee cord, rubber, a rope, or the like.

With continued reference to FIG. 1, apparatus 100 may include one or more depressions 164 in housing 124, a plurality of wheels 168, one or more friction regulators 180 attached to one or more of the plurality of wheels 168. The apparatus 100 may further include an AC to DC converter 148, which is an alternating current to direct current converter configured to convert an electrical charging current from an alternating current to a direct current. As used in this disclosure, an “analog current to direct current converter” is an electrical component that is configured to convert analog current to digital current. An analog current to direct current (AC-DC) converter may include an analog current to direct current power supply and/or transformer. Apparatus 100 may further include a DC to DC buck converter 152 for raising or lowering current and voltage. The apparatus 100 may further comprise a power switch 172 disposed centrally in the apparatus.

With continued reference to FIG. 1, power switch 172 may be disposed within housing 124 and in electrical communication with at least one of electrical cable 132, charging connector 136, charging cable 140, electrical cable connector 144, computing device, processor 108, memory 112, AC to DC converter 148, DC to DC buck converter 152, and lights 176. Power switch may include a button, a knob, a dial, a rocker switch, a touchscreen, a slider, a sliding switch, and the like. Power switch 172 may include an insulating material such as polyethylene, polyurethane, PTFE, wood, or the like.

With continued reference to FIG. 1, apparatus 100 may further include one or more lights 176 disposed on the housing 124. Light 176 may include any light emitting device including a display, a lamp, a light bulb, a neon light, a light-emitting diode (LED), a projector, a laser, a strobe light, an incandescent light, a fluorescent light, a halogen light and the like. Light 176 may emit a variety of wavelengths of light and a variety of intensities. In an embodiment, the emitted wavelengths of light may be determined based on a voltage or current of at least one of the electrical cable or the charging cable. For example, light 176 may emit white light of fixed intensity when the apparatus is powered on but not charging, such as an intensity of 400 lumens. When apparatus 100 is powered on and charging an electric vehicle, processor 108 may be configured by instructions contained on memory 112 to vary the intensity of emitted light and/or the wavelength of emitted light. For example, processor 108 may control the lights to vary between a minimum intensity and a maximum intensity at a certain frequency. In an embodiment, the intensity of emitted light may follow a sinusoidal curve. Additionally or alternatively, processor 108 may alter one or more of the maximum intensity, the minimum intensity, and the frequency of variation as a function of state of charge of a battery or other electrical storage object, a current or voltage (e.g. a current or voltage of charging cable 140 and/or electrical cable 132), a temperature, a pressure, a sensor reading, a user preference, or the like. For example, processor 108 may determine that at the start of a charging cycle, a battery is at 10% state of charge. Processor 108 may define a minimum intensity of emitted light to be 200 lumens, and a maximum intensity of 320 lumens, and a sinusoidal frequency of 0.5Hz. Processor 108 may increase the maximum intensity of the light by 2 lumens for every 1% increase in state of charge. When the battery is charged to 100%, the maximum intensity of the emitted light will be 500 lumens.

With continued reference to FIG. 1, at least one of the one or more lights 176 may be positioned to emit light directly toward the ground. For example, light 176 may be positioned on the bottom of housing 124 such that apparatus 100 appears to emit a glow from beneath housing 124 and indicate a state of apparatus 100.

With continued reference to FIG. 1, apparatus 100 may further include an audio device 184 such as a speaker or other noise-producing device. In an embodiment, audio device 184 may be configured by processor 108 to emit sound based on a function of apparatus 100, such as a charging function, a current or voltage, an emitted light, or the like.

With continued reference to FIG. 1, housing 124 may include one or more depressions 164 that provide an uninterrupted path between internal compartment 204 and an environment external to the apparatus 100. In an embodiment, electrical cable 132 and charging cable 140 may be partially disposed within compartment 204 and an external environment by being placed in one or more of the depressions 164. Depressions 164 may define a mechanical accessibility between the compartment 204 and the external environment.

With continued reference to FIG. 1, apparatus 100 may include a plurality of wheels 168. Wheels 168 may include caster wheels, roller wheels, spinner wheels, skate wheels, and the like. Wheels 168 may be made of nylon, polyurethane, or a similar material. Wheels 168 may be rotatably attached to housing 124. For example, wheels 168 may be capable of swiveling in order to easily move or change direction of apparatus 100.

With continued reference to FIG. 1, one or more wheels 168 may include or be attached to friction regulators 180. Friction regulators 180 may include brakes or other similar devices. Friction regulators 180 may include single side brakes, dual side brakes, poly lock brakes, pneumatic poly cam brakes, or the like.

Now referencing FIG. 2, an alternative view of apparatus 100 is illustrated. FIG. 2 illustrates housing 124, lid 128, lid supports 160, electrical cable 132, charging cable 140, charging connector 136, wheels 168, friction regulator 180, and power switch 172.

Continuing to reference FIG. 2, housing 124 includes compartment 204. Compartment 204 may include internal divider 208 which may partially divide compartment 204 internally. “Partially divided” as used herein is defined as a space being partially separated while still being mechanically accessible. In an embodiment, compartment 204 may be divided radially. “Divided radially,” as used herein, is defined as having a distinct physical separation at an approximately constant radial distance from the center of the compartment 204. In an embodiment, compartment 204 is divided into a first radial portion and a second radial portion. In an embodiment, the first and second radial portion can comprise an inner and outer radial portion. In an embodiment, electrical cable 132 and electrical cable connector 144 are disposed within the second radial portion (equivalently the outer radial portion) and charging cable 140 and charging connector 136 are disposed within the first radial portion (equivalently the inner radial portion). In an embodiment, electrical cable 132 and electrical cable connector 144 are disposed within the first radial portion (equivalently the inner radial portion) and charging cable 140 and charging connector 136 are disposed within the second radial portion (equivalently the outer radial portion). In an embodiment, electrical cable 132 and electrical cable connector 144 are disposed within whichever portion of the compartment that charging cable 140 and charging connector 136 are not disposed within.

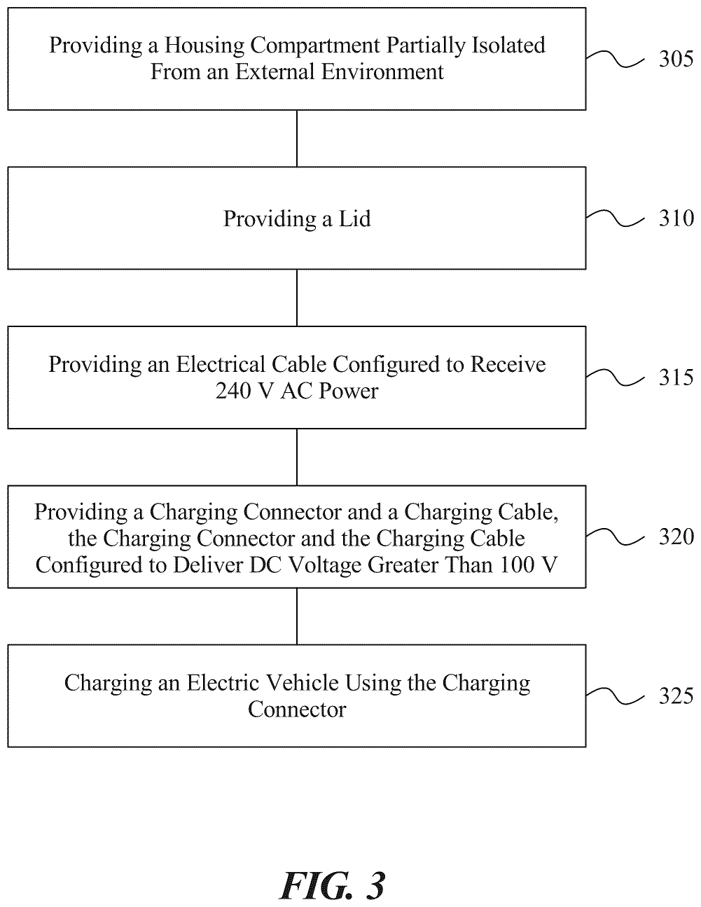

Now referring to FIG. 3, a method 300 for charging an electric vehicle is described. The method 300 comprises: step 305: providing a housing comprising a compartment partially isolated from an external environment; step 310 of providing a lid; step 315 of providing an electrical cable configured to receive 240 V AC power; step 320 of providing a charging connector and a charging cable, the charging connector and the charging cable configured to deliver DC voltage greater than 100 V; and step 325 of charging an electric vehicle using the charging connector. Method 300 may be carried out using or in accordance with embodiments of apparatus 100 illustrated herein.

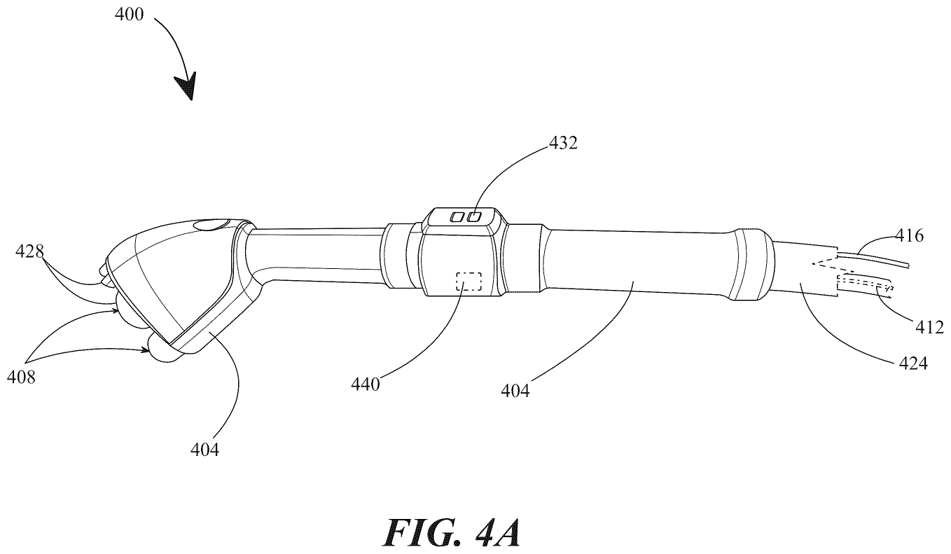

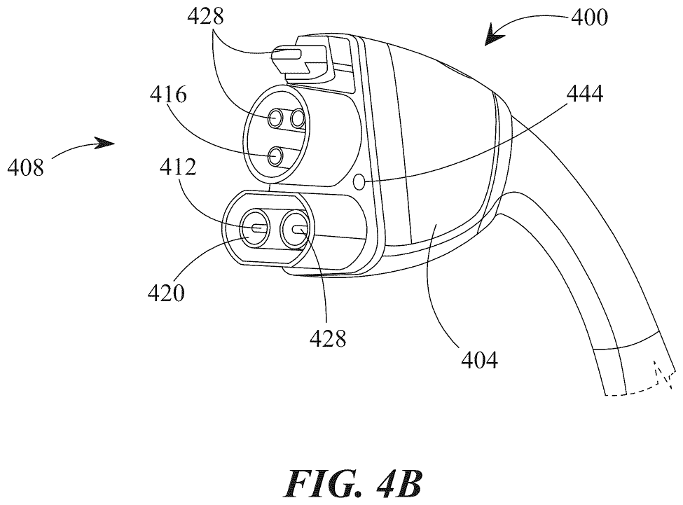

Now referring to FIGS. 4A and 4B, an exemplary embodiment of a charging connector 400 is illustrated. As shown in FIG. 4A, charging connector 400 (also referred to herein as a “connector”) facilitates transfer of electrical power between a power source of a charging station and an electric aircraft, such as a power source of the electric aircraft and/or electrical systems of the electric aircraft. As used in this disclosure, “charging” refers to a process of increasing energy stored within an energy source. In some cases, and without limitation, an energy source may include a battery and charging may include providing electrical power, such as an electrical current, to the battery.

In one or more embodiments, and still referring to FIG. 4A, connector 400 may include a distal end of a flexible tether 424 or a bundle of tethers, e.g., hose, tubing, cables, wires, and the like, attached to a charging unit, such as a charging station or charger. Connector 400 is configured to connect charging unit to an electric aircraft to create an electrical communication between charging unit and electric aircraft, as discussed further in this disclosure. Connector 400 may be configured to removably attach to a port of electric aircraft using, for example, a mating component 428. As used in this disclosure, a “port” is an interface for example of an interface configured to receive another component or an interface configured to transmit and/or receive signal on a computing device. For example, and without limitation, in the case of an electric aircraft port, the port interfaces with a number of conductors 408 and/or a cooling channel 420 by way of receiving connector 400. In the case of a computing device port, the port may provide an interface between a signal and a computing device. A connector may include a male component having a penetrative form and port may include a female component having a receptive form, receptive to the male component. Alternatively or additionally, connector may have a female component and port may have a male component. In some cases, connector may include multiple connections, which may make contact and/or communicate with associated mating components within port, when the connector is mated with the port.

With continued reference to FIG. 4A, connector 400 may include a casing 404. In some cases, casing 404 may protect internal components of connector 400. Casing 404 may be made from various materials, such as metal alloy, aluminum, steel, plastic, synthetic material, semi-synthetic material, polymer, and the like. In some embodiments, casing 404 may be monolithic. In other embodiments, casing 404 may include a plurality of assembled components. Casing 404 and/or connector 400 may be configured to mate with a port of an electric aircraft using a mating component 428. Mating component 428 may include a mechanical or electromechanical mechanism described in this disclosure. For example, without limitation mating may include an electromechanical device used to join electrical conductors and create an electrical circuit. In some cases, mating component 428 may include gendered mating components. Gendered mating components may include a male component, such as a plug, which is inserted within a female component, such as a socket. In some cases, mating between mating components may be removable. In some cases, mating between mating components may be permanent. In some cases, mating may be removable, but require a specialized tool or key for removal. Mating may be achieved by way of one or more of plug and socket mates, pogo pin contact, crown spring mates, and the like. In some cases, mating may be keyed to ensure proper alignment of connector 400. In some cases, mate may be lockable. In one or more embodiments, casing 404 may include controls 432. Controls 432 may be actuated by a user to initiate, terminate, and/or modify parameters charging. For example, and without limitation, a button of controls 432 may be depressed by a user to initiate a transfer of electrical power from charging unit to electric aircraft. Controls 432 may include buttons, switches, slides, a touchscreen, joystick, and the like. In some embodiments, controls 432 may include a screen that displays information related to the charging of an energy source. For example, and without limitation, screen may display an amperage or voltage of electrical power being transferred to energy source of electric aircraft. Screen may also display a calculated amount of time until energy source is charged to a desired amount (e.g., desired state of charge). Screen may also display data detected by components, such as a sensor, of connector and/or electric aircraft. For example, and without limitation, screen may display a temperature of an energy source of electric aircraft. In an exemplary embodiment, a user may actuate, for example, a switch, of control 432 to initiate a cooling of a component of connector 400 and/or electric aircraft in response to displayed information and/or data on screen of connector 400. Initiating of a cooling of one or more embodiments of connector 400 may include a coolant source displacing a coolant within a cooling channel, as discussed further in this disclosure below.

With continued reference to FIG. 4A, mating component 428 of casing 404 may include a fastener. As used in this disclosure, a “fastener” is a physical component that is designed and/or configured to attach or fasten two or more components together. Connector 400 may include one or more attachment components or mechanisms, for example without limitation fasteners, threads, snaps, canted coil springs, and the like. In some cases, connector may be connected to port by way of one or more press fasteners. As used in this disclosure, a “press fastener” is a fastener that couples a first surface to a second surface when the two surfaces are pressed together. Some press fasteners include elements on the first surface that interlock with elements on the second surface; such fasteners include without limitation hook-and-loop fasteners such as VELCRO fasteners produced by Velcro Industries B.V. Limited Liability Company of Curacao Netherlands, and fasteners held together by a plurality of flanged or “mushroom”-shaped elements, such as 3M DUAL LOCK fasteners manufactured by 3M Company of Saint Paul, Minnesota. Press-fastener may also include adhesives, including reusable gel adhesives, GECKSKIN adhesives developed by the University of Massachusetts in Amherst, of Amherst, Massachusetts, or other reusable adhesives. Where press-fastener includes an adhesive, the adhesive may be entirely located on the first surface of the press-fastener or on the second surface of the press-fastener, allowing any surface that can adhere to the adhesive to serve as the corresponding surface. In some cases, connector may be connected to port by way of magnetic force. For example, connector may include one or more of a magnetic, a ferro-magnetic material, and/or an electromagnet. Fastener may be configured to provide removable attachment between connector 400 and port of electric aircraft. As used in this disclosure, “removable attachment” is an attributive term that refers to an attribute of one or more relata to be attached to and subsequently detached from another relata; removable attachment is a relation that is contrary to permanent attachment wherein two or more relata may be attached without any means for future detachment. Exemplary non-limiting methods of permanent attachment include certain uses of adhesives, glues, nails, engineering interference (i.e., press) fits, and the like. In some cases, detachment of two or more relata permanently attached may result in breakage of one or more of the two or more relata.

With continued reference to FIG. 4A, connector 400 may include a controller 440. Connector 400 may include one or more charging cables that each include a conductor 408, which has a distal end approximately located within connector 400 and a proximal end approximately located at an energy source of charging unit. As used in this disclosure, a “conductor” is a component that facilitates conduction. As used in this disclosure, “conduction” is a process by which one or more of heat and/or electricity is transmitted through a substance, for example, when there is a difference of effort (i.e., temperature or electrical potential) between adjoining regions. In some cases, conductor 408 may be configured to charge and/or recharge electric aircraft. For instance, conductor 408 may be connected to an energy source of a charging unit and conductor may be designed and/or configured to facilitate a specified amount of electrical power, current, or current type. For example, conductor 408 may include a direct current conductor. As used in this disclosure, a “direct current conductor” is a conductor configured to carry a direct current for recharging an energy source of electric aircraft. As used in this disclosure, “direct current” is one-directional flow of electric charge. In some cases, conductor may include an alternating current conductor. As used in this disclosure, an “alternating current conductor” is a conductor configured to carry an alternating current for recharging an energy source of electric aircraft. As used in this disclosure, an “alternating current” is a flow of electric charge that periodically reverse direction; in some cases, an alternating current may change its magnitude continuously with in time (e.g., sine wave).

In one or more embodiments, and still referring to FIG. 4A, conductor 408 may include a high-voltage conductor 412. In a non-limiting embodiment, high-voltage conductor 412 may be configured for a potential no less than 200 V. In some embodiments, high-voltage conductor may include a direct current (DC) conductor. High-voltage conductor 412 may include a DC conductor pin, which extends from casing 404 and allows for the flow of DC power into and out of the electric aircraft via port. In other embodiments, high-voltage conductor 412 may include an alternating current (AC) conductor. An AC conductor may include any component responsible for the flow of AC power into and out of the electric aircraft. The AC conductor may include a pin that extends from casing 404 that may allow for a transfer of electrical power between connector and power source of electrical aircraft. In some embodiments, a pin of high-voltage conductor 412 may include a live pin, such that the pin is the supply of DC or AC power. In other embodiments, pin of high-voltage conductor 412 may include a neutral pin, such that the pin is the return path for DC or AC power.

With continued reference to FIG. 4A, conductor may include a low-voltage conductor 416. In a non-limiting embodiment, low-voltage conductor 416 may be configured for a potential no greater than 200 V. Low-voltage conductor 416 may be configured for AC or DC current. In one or more embodiments, low-voltage conductor 416 may be used as an auxiliary charging connector to power auxiliary equipment of electric aircraft. In some embodiments, auxiliary equipment may only be powered using low-voltage conductor 416 such that auxiliary equipment is not powered after charging, thus, auxiliary equipment may be off during in-flight activities.

With continued reference to FIG. 4A, high-voltage conductor 412 and low-voltage conductor 416 may receive an electrical charging current from an energy source of charging unit. As used in this disclosure, an “energy source” is a source of electrical power, for example, for charging a battery. In some cases, energy source may include a charging battery (i.e., a battery used for charging other batteries). A charging battery is notably contrasted with an electric aircraft energy source or battery, which is located for example upon electric aircraft. As used in this disclosure, an “electrical charging current” is a flow of electrical charge that facilitates an increase in stored electrical energy of an energy storage, such as without limitation a battery. Charging battery may include a plurality of batteries, battery modules, and/or battery cells. Charging battery may be configured to store a range of electrical energy, for example a range of between about 5 KWh and about 5,000 KWh. Energy source may house a variety of electrical components. In one embodiment, energy source may contain a solar inverter. Solar inverter may be configured to produce on-site power generation. In one embodiment, power generated from solar inverter may be stored in a charging battery. In some embodiments, charging battery may include a used electric aircraft battery no longer fit for service in an aircraft.

In some embodiments, and still referring to FIG. 4A, charging battery may have a continuous power rating of at least 350 kVA. In other embodiments, charging battery may have a continuous power rating of over 350 kVA. In some embodiments, charging battery may have a battery charge range up to 950 Vdc. In other embodiments, charging battery may have a battery charge range of over 950 Vdc. In some embodiments, charging battery may have a continuous charge current of at least 350 amps. In other embodiments, charging battery may have a continuous charge current of over 350 amps. In some embodiments, charging battery may have a boost charge current of at least 500 amps. In other embodiments, charging battery may have a boost charge current of over 500 amps. In some embodiments, charging battery may include any component with the capability of recharging an energy source of an electric aircraft. In some embodiments, charging battery may include a constant voltage charger, a constant current charger, a taper current charger, a pulsed current charger, a negative pulse charger, an IUI charger, a trickle charger, and a float charger.

In one or more embodiments, and still referring to FIG. 4A, conductor 408 may be an electrical conductor, for example, a wire and/or cable, as previously mentioned above in this disclosure. Exemplary conductor materials may include metals, such as without limitation copper, nickel, steel, and the like. In one or more embodiments, conductor may be disposed within an insulation, such as an insulation sleeve that conductor is at least partially disposed within. For example, and without limitation, conductor 408 may be covered by insulation except for at conductor pin, which may contact a component or interface of port of electric aircraft as part of mating component 428. As used in this disclosure, “communication” is an attribute wherein two or more relata interact with one another, for example within a specific domain or in a certain manner. In some cases, communication between two or more relata may be of a specific domain, such as without limitation electric communication, fluidic communication, informatic communication, mechanic communication, and the like. As used in this disclosure, “electric communication” is an attribute wherein two or more relata interact with one another by way of an electric current or electricity in general. As used in this disclosure, “informatic communication” is an attribute wherein two or more relata interact with one another by way of an information flow or information in general. As used in this disclosure, “mechanic communication” is an attribute wherein two or more relata interact with one another by way of mechanical means, for instance mechanic effort (e.g., force) and flow (e.g., velocity).

Now referring to FIG. 4B, in some embodiments, a charging unit may additionally include an alternating current to direct current converter configured to convert an electrical charging current from an alternating current. As used in this disclosure, an “analog current to direct current converter” is an electrical component that is configured to convert analog current to digital current. An analog current to direct current (AC-DC) converter may include an analog current to direct current power supply and/or transformer. In some cases, AC-DC converter may be located within housing 124 and conductors may provide an alternating current to the electric aircraft by way of conductors 408 and connector 400. Alternatively and/or additionally, in some cases, AC-DC converter may be located outside of an electric aircraft and an electrical charging current may be provided by way of a direct current to the electric aircraft. In some cases, AC-DC converter may be used to recharge a charging batter. In some cases, AC-DC converter may be used to provide electrical power to one or more of coolant source 436, charging battery, and/or controller 440. In some embodiments, charging battery may have a connection to grid power component. Grid power component may be connected to an external electrical power grid. In some embodiments, grid power component may be configured to slowly charge one or more batteries in order to reduce strain on nearby electrical power grids. In one embodiment, grid power component may have an AC grid current of at least 450 amps. In some embodiments, grid power component may have an AC grid current of more or less than 450 amps. In one embodiment, grid power component may have an AC voltage connection of 480 Vac. In other embodiments, grid power component may have an AC voltage connection of above or below 480 Vac. In some embodiments, charging battery may provide power to the grid power component. In this configuration, charging battery may provide power to a surrounding electrical power grid.

With continued reference to FIG. 4B, a conductor 408 may include a control signal conductor configured to conduct a control signal. As used in this disclosure, a “control signal conductor” is a conductor configured to carry a control signal, such as a control signal between an electric aircraft and a charging unit. As used in this disclosure, a “control signal” is an electrical signal that is indicative of information. In this disclosure, “control pilot” is used interchangeably in this application with control signal. In some cases, a control signal may include an analog signal or a digital signal. In some cases, control signal may be communicated from one or more sensors, for example located within electric aircraft (e.g., within an electric aircraft battery) and/or located within connector 400. For example, in some cases, control signal may be associated with a battery within an electric aircraft. For example, control signal may include a battery sensor signal. As used in this disclosure, a “battery sensor signal” is a signal representative of a characteristic of a battery. In some cases, battery sensor signal may be representative of a characteristic of an electric aircraft battery, for example as electric aircraft battery is being recharged. In some versions, controller 440 may additionally include a sensor interface configured to receive a battery sensor signal. Sensor interface may include one or more ports, an analog to digital converter, and the like. Controller 440 may be further configured to control one or more of electrical charging current and coolant flow as a function of sensor signal from a sensor 444 and/or control signal. For example, controller 440 may control a charging battery as a function of a battery sensor signal and/or control signal. In some cases, battery sensor signal may be representative of battery temperature. In some cases, battery sensor signal may represent battery cell swell. In some cases, battery sensor signal may be representative of temperature of electric aircraft battery, for example temperature of one or more battery cells within an electric aircraft battery. In some cases, a sensor, a circuit, and/or a controller 440 may perform one or more signal processing steps on a signal. For instance, sensor, circuit or controller 440 may analyze, modify, and/or synthesize a signal in order to improve the signal, for instance by improving transmission, storage efficiency, or signal to noise ratio.

Exemplary methods of signal processing may include analog, continuous time, discrete, digital, nonlinear, and statistical. Analog signal processing may be performed on non-digitized or analog signals. Exemplary analog processes may include passive filters, active filters, additive mixers, integrators, delay lines, compandors, multipliers, voltage-controlled filters, voltage-controlled oscillators, and phase-locked loops. Continuous-time signal processing may be used, in some cases, to process signals which varying continuously within a domain, for instance time. Exemplary non-limiting continuous time processes may include time domain processing, frequency domain processing (Fourier transform), and complex frequency domain processing. Discrete time signal processing may be used when a signal is sampled non-continuously or at discrete time intervals (i.e., quantized in time). Analog discrete-time signal processing may process a signal using the following exemplary circuits sample and hold circuits, analog time-division multiplexers, analog delay lines and analog feedback shift registers. Digital signal processing may be used to process digitized discrete-time sampled signals. Commonly, digital signal processing may be performed by a computing device or other specialized digital circuits, such as without limitation an application specific integrated circuit (ASIC), a field-programmable gate array (FPGA), or a specialized digital signal processor (DSP). Digital signal processing may be used to perform any combination of typical arithmetical operations, including fixed-point and floating-point, real-valued and complex-valued, multiplication and addition. Digital signal processing may additionally operate circular buffers and lookup tables. Further non-limiting examples of algorithms that may be performed according to digital signal processing techniques include fast Fourier transform (FFT), finite impulse response (FIR) filter, infinite impulse response (IIR) filter, and adaptive filters such as the Wiener and Kalman filters. Statistical signal processing may be used to process a signal as a random function (i.e., a stochastic process), utilizing statistical properties. For instance, in some embodiments, a signal may be modeled with a probability distribution indicating noise, which then may be used to reduce noise in a processed signal.

With continued reference to FIG. 4B, a conductor 408 may include a ground conductor. As used in this disclosure, a “ground conductor” is a conductor configured to be in electrical communication with a ground. As used in this disclosure, a “ground” is a reference point in an electrical circuit, a common return path for electric current, or a direct physical connection to the earth. Ground may include an absolute ground such as earth or ground may include a relative (or reference) ground, for example in a floating configuration. In some cases, charging battery may include one or electrical components configured to control flow of an electric recharging current or switches, relays, direct current to direct current (DC-DC) converters, and the like. In some case, charging battery may include one or more circuits configured to provide a variable current source to provide electric recharging current, for example an active current source. Non-limiting examples of active current sources include active current sources without negative feedback, such as current-stable nonlinear implementation circuits, following voltage implementation circuits, voltage compensation implementation circuits, and current compensation implementation circuits, and current sources with negative feedback, including simple transistor current sources, such as constant currant diodes, Zener diode current source circuits, LED current source circuits, transistor current, and the like, Op-amp current source circuits, voltage regulator circuits, and curpistor tubes, to name a few. In some cases, one or more circuits within charging battery or within communication with charging battery are configured to affect electrical recharging current according to control signal from controller 440, such that the controller 440 may control at least a parameter of the electrical charging current. For example, in some cases, controller 440 may control one or more of current (Amps), potential (Volts), and/or power (Watts) of electrical charging current by way of control signal. In some cases, controller 440 may be configured to selectively engage electrical charging current, for example ON or OFF by way of control signal.

With continued reference to FIG. 4B, a conductor 408 may include a proximity signal conductor. As used in this disclosure, an “proximity signal conductor” is a conductor configured to carry a proximity signal. As used in this disclosure, a “proximity signal” is a signal that is indicative of information about a location of connector. Proximity signal may be indicative of attachment of connector with a port, for instance electric aircraft port and/or test port. In some cases, a proximity signal may include an analog signal, a digital signal, an electrical signal, an optical signal, a fluidic signal, or the like. In some cases, a proximity signal conductor may be configured to conduct a proximity signal indicative of attachment between connector 400 and a port, for example electric aircraft port.

Still referring to FIG. 4B, in some cases, connector 400 may additionally include a proximity sensor. For example, and without limitation, sensor 444 may include a proximity sensor. Proximity sensor may be electrically communicative with a proximity signal conductor. Proximity sensor may be configured to generate a proximity signal as a function of connection between connector 400 and a port, for example port of electric aircraft. As used in this disclosure, a “sensor” is a device that is configured to detect a phenomenon and transmit information related to the detection of the phenomenon. For example, in some cases a sensor may transduce a detected phenomenon, such as without limitation temperature, pressure, and the like, into a sensed signal. As used in this disclosure, a “proximity sensor” is a sensor that is configured to detect at least a phenomenon related to connecter being mated to a port. Proximity sensor may include any sensor described in this disclosure, including without limitation a switch, a capacitive sensor, a capacitive displacement sensor, a doppler effect sensor, an inductive sensor, a magnetic sensor, an optical sensor (such as without limitation a photoelectric sensor, a photocell, a laser rangefinder, a passive charge-coupled device, a passive thermal infrared sensor, and the like), a radar sensor, a reflection sensor, a sonar sensor, an ultrasonic sensor, fiber optics sensor, a Hall effect sensor, and the like.

Still referring to FIG. 4B, in some embodiments, connector 400 may additionally include an isolation monitor conductor configured to conduct an isolation monitoring signal. In some cases, power systems for example charging battery or electric aircraft batteries must remain electrically isolated from communication, control, and/or sensor signals. As used in this disclosure, “isolation” is a state where substantially no communication of a certain type is possible between to components, for example electrical isolation refers to elements which are not in electrical communication. Often signal carrying conductors and components (e.g., sensors) may need to be in relatively close proximity with power systems and/or power carrying conductors. For instance, battery sensors which sense characteristics of batteries, for example batteries within an electric aircraft, are often by virtue of their function placed in close proximity with a battery. A battery sensor that measures battery charge and communicates a signal associated with battery charge back to controller 440 is at risk of becoming unisolated from the battery. In some cases, an isolation monitoring signal will indicate isolation of one or more components. In some cases, an isolation monitoring signal may be generated by an isolation monitoring sensor. Isolation monitoring sensor may include any sensor described in this disclosure, such as without limitation a multi-meter, an impedance meter, and/or a continuity meter. In some cases, isolation from an electrical power (e.g., battery and/or charging battery) may be required for housing of connector 400 and a ground. Isolation monitoring signal may, in some cases, communication information about isolation between an electrical power and ground, for example along a flow path that includes connector 400.

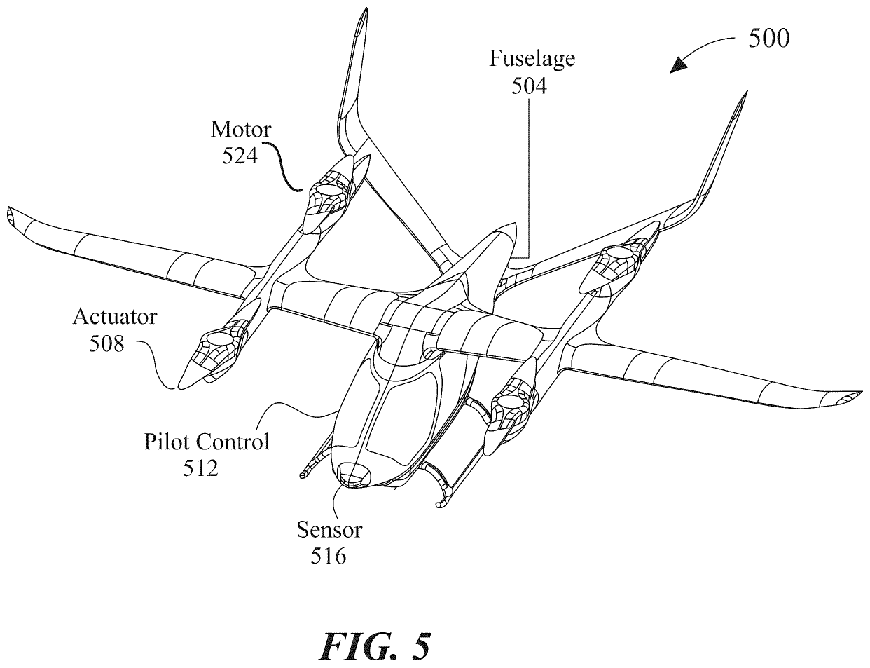

Referring now to FIG. 5, an exemplary embodiment of an aircraft 500 is illustrated. Aircraft 500 may include an electrically powered aircraft (i.e., electric aircraft). In some embodiments, electrically powered aircraft may be an electric vertical takeoff and landing (eVTOL) aircraft. Electric aircraft may be capable of rotor-based cruising flight, rotor-based takeoff, rotor-based landing, fixed-wing cruising flight, airplane-style takeoff, airplane-style landing, and/or any combination thereof. “Rotor-based flight,” as described in this disclosure, is where the aircraft generated lift and propulsion by way of one or more powered rotors coupled with an engine, such as a quadcopter, multi-rotor helicopter, or other vehicle that maintains its lift primarily using downward thrusting propulsors. “Fixed-wing flight,” as described in this disclosure, is where the aircraft is capable of flight using wings and/or foils that generate lift caused by the aircraft's forward airspeed and the shape of the wings and/or foils, such as airplane-style flight.

Still referring to FIG. 5, aircraft 500 may include a fuselage 504. As used in this disclosure a “fuselage” is the main body of an aircraft, or in other words, the entirety of the aircraft except for the cockpit, nose, wings, empennage, nacelles, any and all control surfaces, and generally contains an aircraft's payload. Fuselage 504 may comprise structural elements that physically support the shape and structure of an aircraft. Structural elements may take a plurality of forms, alone or in combination with other types. Structural elements may vary depending on the construction type of aircraft and specifically, the fuselage. Fuselage 504 may comprise a truss structure. A truss structure may be used with a lightweight aircraft and may include welded aluminum tube trusses. A truss, as used herein, is an assembly of beams that create a rigid structure, often in combinations of triangles to create three-dimensional shapes. A truss structure may alternatively comprise titanium construction in place of aluminum tubes, or a combination thereof. In some embodiments, structural elements may comprise aluminum tubes and/or titanium beams. In an embodiment, and without limitation, structural elements may include an aircraft skin. Aircraft skin may be layered over the body shape constructed by trusses. Aircraft skin may comprise a plurality of materials such as aluminum, fiberglass, and/or carbon fiber, the latter of which will be addressed in greater detail later in this paper.

Still referring to FIG. 5, aircraft 500 may include a plurality of actuators 508. Actuator 508 may include any motor and/or propulsor described in this disclosure. In an embodiment, actuator 508 may be mechanically coupled to an aircraft. As used herein, a person of ordinary skill in the art would understand “mechanically coupled” to mean that at least a portion of a device, component, or circuit is connected to at least a portion of the aircraft via a mechanical coupling. Said mechanical coupling can include, for example, rigid coupling, such as beam coupling, bellows coupling, bushed pin coupling, constant velocity, split-muff coupling, diaphragm coupling, disc coupling, donut coupling, elastic coupling, flexible coupling, fluid coupling, gear coupling, grid coupling, Hirth joints, hydrodynamic coupling, jaw coupling, magnetic coupling, Oldham coupling, sleeve coupling, tapered shaft lock, twin spring coupling, rag joint coupling, universal joints, or any combination thereof. As used in this disclosure an “aircraft” is vehicle that may fly. As a non-limiting example, aircraft may include airplanes, helicopters, airships, blimps, gliders, paramotors, and the like thereof. In an embodiment, mechanical coupling may be used to connect the ends of adjacent parts and/or objects of an electric aircraft. Further, in an embodiment, mechanical coupling may be used to join two pieces of rotating electric aircraft components.

With continued reference to FIG. 5, a plurality of actuators 508 may be configured to produce a torque. As used in this disclosure a “torque” is a measure of force that causes an object to rotate about an axis in a direction. For example, and without limitation, torque may rotate an aileron and/or rudder to generate a force that may adjust and/or affect altitude, airspeed velocity, groundspeed velocity, direction during flight, and/or thrust. For example, plurality of actuators 508 may include a component used to produce a torque that affects aircrafts' roll and pitch, such as without limitation one or more ailerons. An “aileron,” as used in this disclosure, is a hinged surface which form part of the trailing edge of a wing in a fixed wing aircraft, and which may be moved via mechanical means such as without limitation servomotors, mechanical linkages, or the like. As a further example, plurality of actuators 508 may include a rudder, which may include, without limitation, a segmented rudder that produces a torque about a vertical axis. Additionally or alternatively, plurality of actuators 508 may include other flight control surfaces such as propulsors, rotating flight controls, or any other structural features which can adjust movement of aircraft 500. Plurality of actuators 508 may include one or more rotors, turbines, ducted fans, paddle wheels, and/or other components configured to propel a vehicle through a fluid medium including, but not limited to air.

Still referring to FIG. 5, plurality of actuators 508 may include at least a propulsor component. As used in this disclosure a “propulsor component” or “propulsor” is a component and/or device used to propel a craft by exerting force on a fluid medium, which may include a gaseous medium such as air or a liquid medium such as water. In an embodiment, when a propulsor twists and pulls air behind it, it may, at the same time, push an aircraft forward with an amount of force and/or thrust. More air pulled behind an aircraft results in greater thrust with which the aircraft is pushed forward. Propulsor component may include any device or component that consumes electrical power on demand to propel an electric aircraft in a direction or other vehicle while on ground or in-flight. In an embodiment, propulsor component may include a puller component. As used in this disclosure a “puller component” is a component that pulls and/or tows an aircraft through a medium. As a non-limiting example, puller component may include a flight component such as a puller propeller, a puller motor, a puller propulsor, and the like. Additionally, or alternatively, puller component may include a plurality of puller flight components. In another embodiment, propulsor component may include a pusher component. As used in this disclosure a “pusher component” is a component that pushes and/or thrusts an aircraft through a medium. As a non-limiting example, pusher component may include a pusher component such as a pusher propeller, a pusher motor, a pusher propulsor, and the like. Additionally, or alternatively, pusher flight component may include a plurality of pusher flight components.

In another embodiment, and still referring to FIG. 5, propulsor may include a propeller, a blade, or any combination of the two. A propeller may function to convert rotary motion from an engine or other power source into a swirling slipstream which may push the propeller forwards or backwards. Propulsor may include a rotating power-driven hub, to which several radial airfoil-section blades may be attached, such that an entire whole assembly rotates about a longitudinal axis. As a non-limiting example, blade pitch of propellers may be fixed at a fixed angle, manually variable to a few set positions, automatically variable (e.g. a “constant-speed” type), and/or any combination thereof as described further in this disclosure. As used in this disclosure a “fixed angle” is an angle that is secured and/or substantially unmovable from an attachment point. For example, and without limitation, a fixed angle may be an angle of 2.2° inward and/or 1.7° forward. As a further non-limiting example, a fixed angle may be an angle of 3.6° outward and/or 2.7° backward. In an embodiment, propellers for an aircraft may be designed to be fixed to their hub at an angle similar to the thread on a screw makes an angle to the shaft; this angle may be referred to as a pitch or pitch angle which may determine a speed of forward movement as the blade rotates. Additionally or alternatively, propulsor component may be configured having a variable pitch angle. As used in this disclosure a “variable pitch angle” is an angle that may be moved and/or rotated. For example, and without limitation, propulsor component may be angled at a first angle of 3.3° inward, wherein propulsor component may be rotated and/or shifted to a second angle of 1.7° outward.

Still referring to FIG. 5, propulsor may include a thrust element which may be integrated into the propulsor. Thrust element may include, without limitation, a device using moving or rotating foils, such as one or more rotors, an airscrew or propeller, a set of airscrews or propellers such as contra-rotating propellers, a moving or flapping wing, or the like. Further, a thrust element, for example, can include without limitation a marine propeller or screw, an impeller, a turbine, a pump-jet, a paddle or paddle-based device, or the like.

With continued reference to FIG. 5, plurality of actuators 508 may include power sources, control links to one or more elements, fuses, and/or mechanical couplings used to drive and/or control any other flight component. Plurality of actuators 508 may include a motor that operates to move one or more flight control components and/or one or more control surfaces, to drive one or more propulsors, or the like. A motor may be driven by direct current (DC) electric power and may include, without limitation, brushless DC electric motors, switched reluctance motors, induction motors, or any combination thereof. Alternatively or additionally, a motor may be driven by an inverter. A motor may also include electronic speed controllers, inverters, or other components for regulating motor speed, rotation direction, and/or dynamic braking.

Still referring to FIG. 5, plurality of actuators 508 may include an energy source. An energy source may include, for example, a generator, a photovoltaic device, a fuel cell such as a hydrogen fuel cell, direct methanol fuel cell, and/or solid oxide fuel cell, an electric energy storage device (e.g. a capacitor, an inductor, and/or a battery). An energy source may also include a battery cell, or a plurality of battery cells connected in series into a module and each module connected in series or in parallel with other modules. Configuration of an energy source containing connected modules may be designed to meet an energy or power requirement and may be designed to fit within a designated footprint in an electric aircraft in which system may be incorporated.

In an embodiment, and still referring to FIG. 5, an energy source may be used to provide a steady supply of electrical power to a load over a flight by an electric aircraft 500. For example, energy source may be capable of providing sufficient power for “cruising” and other relatively low-energy phases of flight. An energy source may also be capable of providing electrical power for some higher-power phases of flight as well, particularly when the energy source is at a high SOC, as may be the case for instance during takeoff. In an embodiment, energy source may include an emergency power unit which may be capable of providing sufficient electrical power for auxiliary loads including without limitation, lighting, navigation, communications, de-icing, steering, or other systems requiring power or energy. Further, energy source may be capable of providing sufficient power for controlled descent and landing protocols, including, without limitation, hovering descent, or runway landing. As used herein the energy source may have high power density where electrical power an energy source can usefully produce per unit of volume and/or mass is relatively high. As used in this disclosure, “electrical power” is a rate of electrical energy per unit time. An energy source may include a device for which power that may be produced per unit of volume and/or mass has been optimized, for instance at an expense of maximal total specific energy density or power capacity. Non-limiting examples of items that may be used as at least an energy source include batteries used for starting applications including Li ion batteries which may include NCA, NMC, Lithium iron phosphate (LiFePO4) and Lithium Manganese Oxide (LMO) batteries, which may be mixed with another cathode chemistry to provide more specific power if the application requires Li metal batteries, which have a lithium metal anode that provides high power on demand, Li ion batteries that have a silicon or titanite anode, energy source may be used, in an embodiment, to provide electrical power to an electric aircraft or drone, such as an electric aircraft vehicle, during moments requiring high rates of power output, including without limitation takeoff, landing, thermal de-icing and situations requiring greater power output for reasons of stability, such as high turbulence situations, as described in further detail below. A battery may include, without limitation a battery using nickel based chemistries such as nickel cadmium or nickel metal hydride, a battery using lithium ion battery chemistries such as a nickel cobalt aluminum (NCA), nickel manganese cobalt (NMC), lithium iron phosphate (LiFePO4), lithium cobalt oxide (LCO), and/or lithium manganese oxide (LMO), a battery using lithium polymer technology, lead-based batteries such as without limitation lead acid batteries, metal-air batteries, or any other suitable battery. Persons skilled in the art, upon reviewing the entirety of this disclosure, will be aware of various devices of components that may be used as an energy source.

Still referring to FIG. 5, an energy source may include a plurality of energy sources, referred to herein as a module of energy sources. Module may include batteries connected in parallel or in series or a plurality of modules connected either in series or in parallel designed to satisfy both power and energy requirements. Connecting batteries in series may increase a potential of at least an energy source which may provide more power on demand. High potential batteries may require cell matching when high peak load is needed. As more cells are connected in strings, there may exist a possibility of one cell failing which may increase resistance in module and reduce overall power output as voltage of the module may decrease as a result of that failing cell. Connecting batteries in parallel may increase total current capacity by decreasing total resistance, and it also may increase overall amp-hour capacity. Overall energy and power outputs of at least an energy source may be based on individual battery cell performance or an extrapolation based on a measurement of at least an electrical parameter. In an embodiment where energy source includes a plurality of battery cells, overall power output capacity may be dependent on electrical parameters of each individual cell. If one cell experiences high self-discharge during demand, power drawn from at least an energy source may be decreased to avoid damage to a weakest cell. Energy source may further include, without limitation, wiring, conduit, housing, cooling system and battery management system. Persons skilled in the art will be aware, after reviewing the entirety of this disclosure, of many different components of an energy source.

Still referring to FIG. 5, according to some embodiments, an energy source may include an emergency power unit (EPU) (i.e., auxiliary power unit). As used in this disclosure an “emergency power unit” is an energy source as described herein that is configured to power an essential system for a critical function in an emergency, for instance without limitation when another energy source has failed, is depleted, or is otherwise unavailable. Exemplary non-limiting essential systems include navigation systems, such as MFD, GPS, VOR receiver or directional gyro, and other essential flight components, such as propulsors.

Still referring to FIG. 5, another exemplary actuator may include landing gear. Landing gear may be used for take-off and/or landing/Landing gear may be used to contact ground while aircraft 500 is not in flight.

Still referring to FIG. 5, aircraft 500 may include a pilot control 512, including without limitation, a hover control, a thrust control, an inceptor stick, a cyclic, and/or a collective control. As used in this disclosure a “collective control” or “collective” is a mechanical control of an aircraft that allows a pilot to adjust and/or control the pitch angle of the plurality of actuators 508. For example and without limitation, collective control may alter and/or adjust the pitch angle of all of the main rotor blades collectively. For example, and without limitation pilot control 512 may include a yoke control. As used in this disclosure a “yoke control” is a mechanical control of an aircraft to control the pitch and/or roll. For example and without limitation, yoke control may alter and/or adjust the roll angle of aircraft 500 as a function of controlling and/or maneuvering ailerons. In an embodiment, pilot control 512 may include one or more footbrakes, control sticks, pedals, throttle levels, and the like thereof. In another embodiment, and without limitation, pilot control 512 may be configured to control a principal axis of the aircraft. As used in this disclosure a “principal axis” is an axis in a body representing one three dimensional orientations. For example, and without limitation, principal axis or more yaw, pitch, and/or roll axis. Principal axis may include a yaw axis. As used in this disclosure a “yaw axis” is an axis that is directed towards the bottom of the aircraft, perpendicular to the wings. For example, and without limitation, a positive yawing motion may include adjusting and/or shifting the nose of aircraft 500 to the right. Principal axis may include a pitch axis. As used in this disclosure a “pitch axis” is an axis that is directed towards the right laterally extending wing of the aircraft. For example, and without limitation, a positive pitching motion may include adjusting and/or shifting the nose of aircraft 500 upwards. Principal axis may include a roll axis. As used in this disclosure a “roll axis” is an axis that is directed longitudinally towards the nose of the aircraft, parallel to the fuselage. For example, and without limitation, a positive rolling motion may include lifting the left and lowering the right wing concurrently.

Still referring to FIG. 5, pilot control 512 may be configured to modify a variable pitch angle. For example, and without limitation, pilot control 512 may adjust one or more angles of attack of a propeller. As used in this disclosure an “angle of attack” is an angle between the chord of the propeller and the relative wind. For example, and without limitation angle of attack may include a propeller blade angled 3.2°. In an embodiment, pilot control 512 may modify the variable pitch angle from a first angle of 2.71° to a second angle of 3.82°. Additionally or alternatively, pilot control 512 may be configured to translate a pilot desired torque for flight component 308. For example, and without limitation, pilot control 512 may translate that a pilot's desired torque for a propeller be 160lb. ft. of torque. As a further non-limiting example, pilot control 512 may introduce a pilot's desired torque for a propulsor to be 290 lb. ft. of torque.

Still referring to FIG. 5, aircraft 500 may include a loading system. A loading system may include a system configured to load an aircraft of either cargo or personnel. For instance, some exemplary loading systems may include a swing nose, which is configured to swing the nose of aircraft 500 of the way thereby allowing direct access to a cargo bay located behind the nose. A notable exemplary swing nose aircraft is Boeing 747.

Still referring to FIG. 5, aircraft 500 may include a sensor 516. Sensor 516 may include any sensor or noise monitoring circuit described in this disclosure. Sensor 516 may be configured to sense a characteristic of pilot control 512. Sensor may be a device, module, and/or subsystem, utilizing any hardware, software, and/or any combination thereof to sense a characteristic and/or changes thereof, in an instant environment, for instance without limitation a pilot control 512, which the sensor is proximal to or otherwise in a sensed communication with, and transmit information associated with the characteristic, for instance without limitation digitized data. Sensor 516 may be mechanically and/or communicatively coupled to aircraft 500, including, for instance, to at least a pilot control 512. Sensor 516 may be configured to sense a characteristic associated with at least a pilot control 512. An environmental sensor may include without limitation one or more sensors used to detect ambient temperature, barometric pressure, and/or air velocity, one or more motion sensors which may include without limitation gyroscopes, accelerometers, inertial measurement unit (IMU), and/or magnetic sensors, one or more humidity sensors, one or more oxygen sensors, or the like. Additionally or alternatively, sensor 516 may include at least a geospatial sensor. Sensor 516 may be located inside an aircraft; and/or be included in and/or attached to at least a portion of the aircraft. Sensor may include one or more proximity sensors, displacement sensors, vibration sensors, and the like thereof. Sensor may be used to monitor the status of aircraft 500 for both critical and non-critical functions. Sensor may be incorporated into vehicle or aircraft or be remote.

Still referring to FIG. 5, in some embodiments, sensor 516 may be configured to sense a characteristic associated with any pilot control described in this disclosure. Non-limiting examples of a sensor 516 may include an inertial measurement unit (IMU), an accelerometer, a gyroscope, a proximity sensor, a pressure sensor, a light sensor, a pitot tube, an air speed sensor, a position sensor, a speed sensor, a switch, a thermometer, a strain gauge, an acoustic sensor, and an electrical sensor. In some cases, sensor 516 may sense a characteristic as an analog measurement, for instance, yielding a continuously variable electrical potential indicative of the sensed characteristic. In these cases, sensor 516 may additionally comprise an analog to digital converter (ADC) as well as any additionally circuitry, such as without limitation a Whetstone bridge, an amplifier, a filter, and the like. For instance, in some cases, sensor 516 may comprise a strain gage configured to determine loading of one or flight components, for instance landing gear. Strain gage may be included within a circuit comprising a Whetstone bridge, an amplified, and a bandpass filter to provide an analog strain measurement signal having a high signal to noise ratio, which characterizes strain on a landing gear member. An ADC may then digitize analog signal produces a digital signal that can then be transmitted other systems within aircraft 500, for instance without limitation a computing system, a pilot display, and a memory component. Alternatively or additionally, sensor 516 may sense a characteristic of a pilot control 512 digitally. For instance in some embodiments, sensor 516 may sense a characteristic through a digital means or digitize a sensed signal natively. In some cases, for example, sensor 516 may include a rotational encoder and be configured to sense a rotational position of a pilot control; in this case, the rotational encoder digitally may sense rotational “clicks” by any known method, such as without limitation magnetically, optically, and the like.

Still referring to FIG. 5, electric aircraft 500 may include at least a motor 524, which may be mounted on a structural feature of the aircraft. Design of motor 524 may enable it to be installed external to structural member (such as a boom, nacelle, or fuselage) for easy maintenance access and to minimize accessibility requirements for the structure.; this may improve structural efficiency by requiring fewer large holes in the mounting area. In some embodiments, motor 524 may include two main holes in top and bottom of mounting area to access bearing cartridge. Further, a structural feature may include a component of electric aircraft 500. For example, and without limitation structural feature may be any portion of a vehicle incorporating motor 524, including any vehicle as described in this disclosure. As a further non-limiting example, a structural feature may include without limitation a wing, a spar, an outrigger, a fuselage, or any portion thereof; persons skilled in the art, upon reviewing the entirety of this disclosure, will be aware of many possible features that may function as at least a structural feature. At least a structural feature may be constructed of any suitable material or combination of materials, including without limitation metal such as aluminum, titanium, steel, or the like, polymer materials or composites, fiberglass, carbon fiber, wood, or any other suitable material. As a non-limiting example, at least a structural feature may be constructed from additively manufactured polymer material with a carbon fiber exterior; aluminum parts or other elements may be enclosed for structural strength, or for purposes of supporting, for instance, vibration, torque, or shear stresses imposed by at least propulsor. Persons skilled in the art, upon reviewing the entirety of this disclosure, will be aware of various materials, combinations of materials, and/or constructions techniques.

Still referring to FIG. 5, electric aircraft 500 may include a vertical takeoff and landing aircraft (eVTOL). As used herein, a vertical take-off and landing (eVTOL) aircraft is one that can hover, take off, and land vertically. An eVTOL, as used herein, is an electrically powered aircraft typically using an energy source, of a plurality of energy sources to power the aircraft. In order to optimize the power and energy necessary to propel the aircraft. eVTOL may be capable of rotor-based cruising flight, rotor-based takeoff, rotor-based landing, fixed-wing cruising flight, airplane-style takeoff, airplane-style landing, and/or any combination thereof. Rotor-based flight, as described herein, is where the aircraft generated lift and propulsion by way of one or more powered rotors coupled with an engine, such as a “quad copter,” multi-rotor helicopter, or other vehicle that maintains its lift primarily using downward thrusting propulsors. Fixed-wing flight, as described herein, is where the aircraft is capable of flight using wings and/or foils that generate life caused by the aircraft's forward airspeed and the shape of the wings and/or foils, such as airplane-style flight.

With continued reference to FIG. 5, a number of aerodynamic forces may act upon the electric aircraft 500 during flight. Forces acting on electric aircraft 500 during flight may include, without limitation, thrust, the forward force produced by the rotating element of the electric aircraft 500 and acts parallel to the longitudinal axis. Another force acting upon electric aircraft 500 may be, without limitation, drag, which may be defined as a rearward retarding force which is caused by disruption of airflow by any protruding surface of the electric aircraft 500 such as, without limitation, the wing, rotor, and fuselage. Drag may oppose thrust and acts rearward parallel to the relative wind. A further force acting upon electric aircraft 500 may include, without limitation, weight, which may include a combined load of the electric aircraft 500 itself, crew, baggage, and/or fuel. Weight may pull electric aircraft 500 downward due to the force of gravity. An additional force acting on electric aircraft 500 may include, without limitation, lift, which may act to oppose the downward force of weight and may be produced by the dynamic effect of air acting on the airfoil and/or downward thrust from the propulsor of the electric aircraft. Lift generated by the airfoil may depend on speed of airflow, density of air, total area of an airfoil and/or segment thereof, and/or an angle of attack between air and the airfoil. For example, and without limitation, electric aircraft 500 are designed to be as lightweight as possible. Reducing the weight of the aircraft and designing to reduce the number of components is essential to optimize the weight. To save energy, it may be useful to reduce weight of components of electric aircraft 500, including without limitation propulsors and/or propulsion assemblies. In an embodiment, motor may eliminate need for many external structural features that otherwise might be needed to join one component to another component. Motor may also increase energy efficiency by enabling a lower physical propulsor profile, reducing drag and/or wind resistance. This may also increase durability by lessening the extent to which drag and/or wind resistance add to forces acting on electric aircraft 500 and/or propulsors.

Exemplary embodiments of electrical cable 132, charging cable 140, and charging connector 136 parameters may be further understood without limitation, with reference to the table below.

| | Min. | | Max. | | Nom. | |
|---|---|---|---|---|---|---|
| Electrical charging | 1 | KW | 200 | KW | 20 | KW |
| current power (AC) | | | | | | |
| Electrical charging | 10 | Amps | 5000 | Amps | 500 | Amps |
| current (AC) | | | | | | |
| Electrical Voltage | 0.5 | V | 5000 | V | 1000 | V |
| (AC) | | | | | | |
| Electrical charging | 0.1 | KW | 5 | KW | 500 | KW |
| current power (DC) | | | | | | |
| Electrical charging | 1 | Amp | 5000 | Amps | 500 | Amps |
| current (DC) | | | | | | |
| Electrical Voltage | 0.5 | V | 5000 | V | 1000 | V |
| (DC) | | | | | | |
| Battery acceptable | −30 | ° C. | +50 | ° C. | 0 | ° C. |
| temperature change | | | | | | |
| during charging | | | | | | |
| Conductor acceptable | −30 | ° C. | +50 | ° C. | 0 | ° C. |
| temperature change | | | | | | |
| during charging | | | | | | |

| | |
|---|---|
| Coolant | Air, water, water-glycol mix, anti-freeze, Fluorinert ™, ethylene glycol, |
| | propylene glycol, any combination thereof, and the like. |
| Connector-Port mating | Mated First: coolant flow source, proximity contact, isolation monitor |
| sequence | contacts. Mated Last: AC conductor, DC conductor, control signal. |
| Conductor materials | Copper, copper-alloys, noble metals, non-noble metals, carbon, diamond, |
| | graphite, platinum group metals, and the like. |
| Conductor coatings | Copper, copper-alloys, noble metals, non-noble metals, carbon, diamond, |
| | graphite, hard gold, hard gold flashed palladium-nickel (e.g., 80/20), tin, |
| | silver, diamond-like carbon, platinum-group metals, and the like. |
| Handle Type | Pistol grip, jug, pull, lever, chest handle, extruded pull, ledge, flush pull, |
| | pull out/extendable/retractable, T, two-point |
| Handle Materials | Wood, thermopolymers, thermosets, PVC, PTFE, polycarbonate, |
| | thermosets, epoxy resin, fiber-reinforced thermoplastics, fiber-reinforced |
| | thermosets, rubber, ABS, polypropylene |
| Handle Coatings | Silicone, fluoropolymer, PTFE, PVC, any insulator deposited using |
| | chemical vapor deposition, any insulator deposited using physical vapor |
| | deposition, polysiloxane |

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module. As used herein, “module” may refer to a hardware module or a software module. A hardware module is any collection of hardware configured to perform at least a specified task. A software module, conversely, is any collection of software instructions configured to perform at least a specified task.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs, one or more hard disk drives in combination with a computer memory, a distributed storage system such as cloud storage, and the like. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

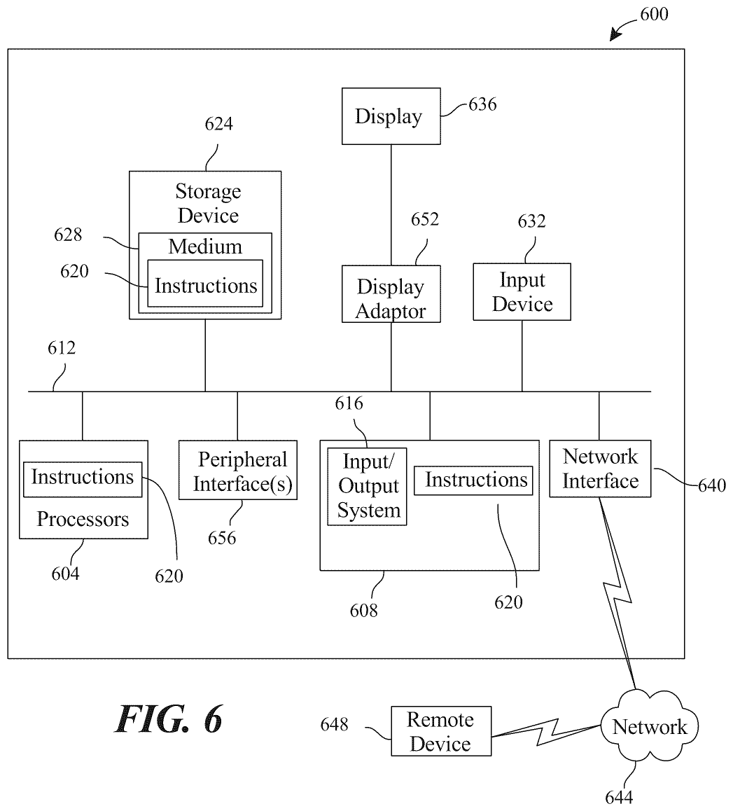

FIG. 6 shows a diagrammatic representation of one embodiment of a computing device in the exemplary form of a computer system 600 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 600 includes a processor 604 and a memory 608 that communicate with each other, and with other components, via a bus 612. Bus 612 may include any of several types of bus structures including, but not limited to, a memory bus, a memory controller, a peripheral bus, a local bus, and any combinations thereof, using any of a variety of bus architectures.

Processor 604 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 604 may be organized according to Von Neumann and/or Harvard architecture as a non-limiting example. Processor 604 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 608 may include various components (e.g., machine-readable media) including, but not limited to, a random-access memory component, a read only component, and any combinations thereof. In one example, a basic input/output system 616 (BIOS), including basic routines that help to transfer information between elements within computer system 600, such as during start-up, may be stored in memory 608. Memory 608 may also include (e.g., stored on one or more machine-readable media) instructions (e.g., software) 620 embodying any one or more of the aspects and/or methodologies of the present disclosure. In another example, memory 608 may further include any number of program modules including, but not limited to, an operating system, one or more application programs, other program modules, program data, and any combinations thereof.

Computer system 600 may also include a storage device 624. Examples of a storage device (e.g., storage device 624) include, but are not limited to, a hard disk drive, a magnetic disk drive, an optical disc drive in combination with an optical medium, a solid-state memory device, and any combinations thereof. Storage device 624 may be connected to bus 612 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 624 (or one or more components thereof) may be removably interfaced with computer system 600 (e.g., via an external port connector (not shown)). Particularly, storage device 624 and an associated machine-readable medium 628 may provide nonvolatile and/or volatile storage of machine-readable instructions, data structures, program modules, and/or other data for computer system 600. In one example, software 620 may reside, completely or partially, within machine-readable medium 628. In another example, software 620 may reside, completely or partially, within processor 604.

Computer system 600 may also include an input device 632. In one example, a user of computer system 600 may enter commands and/or other information into computer system 600 via input device 632. Examples of an input device 632 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 632 may be interfaced to bus 612 via any of a variety of interfaces (not shown) including, but not limited to, a serial interface, a parallel interface, a game port, a USB interface, a FIREWIRE interface, a direct interface to bus 612, and any combinations thereof. Input device 632 may include a touch screen interface that may be a part of or separate from display 636, discussed further below. Input device 632 may be utilized as a user selection device for selecting one or more graphical representations in a graphical interface as described above.

A user may also input commands and/or other information to computer system 600 via storage device 624 (e.g., a removable disk drive, a flash drive, etc.) and/or network interface device 640. A network interface device, such as network interface device 640, may be utilized for connecting computer system 600 to one or more of a variety of networks, such as network 644, and one or more remote devices 648 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 644, may employ a wired and/or a wireless mode of communication. In general, any network topology may be used. Information (e.g., data, software 620, etc.) may be communicated to and/or from computer system 600 via network interface device 640.

Computer system 600 may further include a video display adapter 652 for communicating a displayable image to a display device, such as display device 636. Examples of a display device include, but are not limited to, a liquid crystal display (LCD), a cathode ray tube (CRT), a plasma display, a light emitting diode (LED) display, and any combinations thereof. Display adapter 652 and display device 636 may be utilized in combination with processor 604 to provide graphical representations of aspects of the present disclosure. In addition to a display device, computer system 600 may include one or more other peripheral output devices including, but not limited to, an audio speaker, a printer, and any combinations thereof. Such peripheral output devices may be connected to bus 612 via a peripheral interface 656. Examples of a peripheral interface include, but are not limited to, a serial port, a USB connection, a FIREWIRE connection, a parallel connection, and any combinations thereof.

If not sufficiently clear from contextual or plain and ordinary usage, the terms “about,” “around,” “approximately,” and “substantially,” when used to modify a value, number, figure, quantity, or other term, can be understood to mean ±20% of the modified value, inclusive. For instance, if not sufficiently clear from contextual or plain and ordinary usage, “about 10” can be understood to mean “from 8 to 12 inclusive”. If not sufficiently clear from contextual or plain and ordinary usage, the term “relatively” is used to indicate that one of ordinary skill in the art would more closely associate the described value or modifier with the term it modifies (such as high) than another term in a similar class of words (such as low or medium). For instance, if a temperature is described as being “relatively high,” one of ordinary skill in the art would more closely associate said temperature with “high” temperatures than “medium” or “low” temperatures. In another example, if a tire pressure between 30-33 psi is considered “standard,” then the term “relatively low pressure” would indicate that the stated pressure would be more readily identified by one of ordinary skill in the art as being “low” than being “standard;” for instance, 26 psi.

As used herein, “and/or” is meant to include all possible permutations of “and” and “or”. “And/or” may indicate every element of a specified grouping, combinations of less than all elements, or one element. For example, A, B, and/or C can mean any single one of A, B, or C; A and B but not C, B and C but not A, A and C but not B; and A, B, and C together.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for charging an electric vehicle, the apparatus comprising:
a housing comprising a compartment partially isolated from an external environment;
an internal divider partially dividing the compartment;
a power switch in the center of the internal divider;
a lid;
an electrical cable;
a charging connector and a charging cable, the charging connector and the charging cable configured to deliver DC voltage greater than 100 V; and
one or more lights on a bottom of the housing emitting light towards the ground,
wherein the light emitted by the one or more lights provides an indication of the operating state of an electrical storage object of the electric vehicle.

2. (canceled)

3. The apparatus of claim 1, wherein the housing comprises one or more depressions defining a mechanical accessibility between the compartment and the external environment.

4. The apparatus of claim 1, wherein the compartment has a first radial portion including an electrical cable entirely surrounding a second radial portion including a charging cable, wherein the first radial portion and the second radial portion are concentric and stored in a compartment within the housing, and
wherein the electrical cable is disposed within one of the first radial portion and the second radial portion, and wherein the charging cable is disposed within a portion of the compartment in which the electrical cable is not disposed.

5. The apparatus of claim 1, wherein the lid is movably attached to the housing.

6. The apparatus of claim 1, further comprising a plurality of wheels.

7. The apparatus of claim 6, wherein one or more of the plurality of wheels comprises a friction regulator.

8. The apparatus of claim 1, wherein the charging connector comprises at least two direct current (DC) charging wires.

9. The apparatus of claim 8, wherein the charging cable is configured to transmit up to 5 MW of DC power.

10. The apparatus of claim 1, further comprising a DC to DC buck converter disposed within the housing.

11. The apparatus of claim 1, further comprising a power switch disposed within the housing and in electrical communication with at least one of the electrical cable and the charging cable.

12-14. (canceled)

15. A method for charging an electric vehicle, the method comprising:
providing a housing comprising a compartment partially isolated from an external environment;
providing an internal divider partially dividing the compartment;
providing a power switch in the center of the internal divider;
providing a lid;
providing an electrical cable configured to receive 240 V AC power;
providing a charging connector and a charging cable, the charging connector and the charging cable configured to deliver DC voltage greater than 100 V;
charging an electric vehicle using the charging connector;
selecting a wavelength of light to be emitted from one or more lights attached to the housing based on a voltage or current of at least one of the electrical cable or the charging cable; and
emitting the wavelength of light from at least one of the one or more lights.

16. (canceled)

17. The method of claim 15, further comprising biasing the charging cable to a voltage of 500 V or greater.

18. The method of claim 15, further comprising converting an electrical current from AC to DC within the housing.

19. The method of claim 18, further comprising increasing a DC current using a DC to DC buck converter disposed within the housing.

20. The method of claim 15, wherein charging the electric vehicle using the charging connector comprises providing greater than 100 kW of power through the charging connector.

21. The apparatus of claim 1, further comprising a screen on the charging connector and displaying information related to the indication of the operating state of the electrical storage object of the electric vehicle.

22. The apparatus of claim 1, wherein an intensity of emitted light of the one or more lights follows a sinusoidal curve.

23. The apparatus of claim 1, wherein a frequency of variation of an intensity of emitted light of the one or more lights is a function of a state of charge of the electrical storage object.
